(19) United States
(12) Patent Application Publication
(10) Pub. No.: US 2018/0047336 A1
(43) Pub. Date: Feb. 15, 2018

(54) DISPLAY APPARATUS

(71) Applicant: HON HAI PRECISION INDUSTRY CO., LTD., New Taipei (TW)

(72) Inventors: PO-FU CHEN, New Taipei (TW); KUO-SHENG LEE, New Taipei (TW); CHUNG-WEN LAI, New Taipei (TW)

(21) Appl. No.: 15/674,540

(22) Filed: Aug. 11, 2017

Related U.S. Application Data
(60) Provisional application No. 62/374,101, filed on Aug. 12, 2016.

(51) Int. Cl. G09G 3/3233; G09G 3/3266; G09G 3/3275

(52) U.S. Cl. CPC G09G 3/3233; G09G 3/3275; G09G 3/3266; G09G 2330/02; G09G 2300/0426; G09G 2320/043

(57) ABSTRACT

A display apparatus comprises a plurality of scan lines and a plurality of data lines intersected with the scan lines in a grid, a plurality of pixel units, a first driving circuit for providing a plurality of scanning signals to the plurality of pixel units, and a plurality of pixel driving circuits. Each pixel driving circuit corresponds to one of the plurality of pixel units, and drives the corresponding pixel unit. Each pixel driving circuit comprises a switching transistor, a driving transistor, an organic light emitting diode and a reset transistor. The reset transistor pulls down a voltage applied on the driving transistor during a reset period under a control of a received another scanning signal having a phase previous to the scanning signal applied on a corresponding scan line being selected.

### CROSS-REFERENCE TO RELATED APPLICATIONS

This application claims priority to U.S. provisional patent application No. 62/374,101 filed on Aug. 12, 2016, the contents of which are incorporated by reference herein.

### FIELD

The present disclosure relates to a display apparatus.

### BACKGROUND

An OLED display apparatus includes a plurality of pixels and a plurality of pixel driving circuits. Each of the pixels corresponds to one of the pixel driving circuit, and is driven by a gate driving circuit and a source driving circuit to display images. The driving circuit includes a driving transistor, a switching transistor, a capacitor, and an organic light emitting diode (OLED). The driving transistor controls a driving current flowing in the OLED. The capacitor uniformly holds a gate voltage of the driving transistor during one frame. The switching transistor stores a data voltage in the capacitor. The current flowing in the OLED relates to a lamination of the pixel. A threshold voltage of the driving transistor is adjustable depending on a process deviation, and electrical characteristics of the driving transistor are degraded based on a driving time. For achieving a desired luminance and increasing life span of the OLED display apparatus, thus a compensation circuit of the pixel driving circuit is needed. Therefore, there is room for improvement in the art.

### BRIEF DESCRIPTION OF THE FIGURES

Implementations of the present technology will now be described, by way of example only, with reference to the attached figures, wherein:

FIG. 1 is a plan view of an exemplary embodiment of a display apparatus, the display apparatus comprises a plurality of driving circuits.

FIG. 2 is a circuit diagram view of a first exemplary embodiment of the driving circuit connected with a data scan line, a first scan line, a second scan line, and a third line of FIG. 1.

FIG. 3 is a diagrammatic view of the driving circuit of FIG. 2.

FIG. 4 is a circuit diagram view of the driving circuit of FIG. 2 in a rest period.

FIG. 5 is a circuit diagram view of the driving circuit of FIG. 2 in a preparation compensation period.

FIG. 6 is a circuit diagram view of the driving circuit of FIG. 2 in a compensation period.

FIG. 7 is a circuit diagram view of the driving circuit of FIG. 2 in a programming period.

FIG. 8 is a circuit diagram view of the driving circuit of FIG. 2 in an illumination duty period.

FIG. 9 is a circuit diagram view of the driving circuit of FIG. 2 in an illumination period.

FIG. 10 is circuit diagram of a second exemplary embodiment of the driving circuit connected with a data scan line, a first scan line, a second scan line, and a third line of FIG. 1.

FIG. 11 is a diagrammatic view of the driving circuit of FIG. 10.

FIG. 12 is a circuit diagram view of the driving circuit of FIG. 10 in a preparation compensation period.

FIG. 13 is a circuit diagram view of the driving circuit of FIG. 10 in a compensation period.

FIG. 14 is a circuit diagram view of the driving circuit of FIG. 10 in a programming period.

FIG. 15 is a circuit diagram view of the driving circuit of FIG. 10 in an illumination period.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

As discussed above, electrical characteristics of the driving transistor are degraded based on a driving time. Exemplary embodiments of the present application relate to a display apparatus that substantially compensates the electrical characteristics of the driving transistor in the pixel driving circuit. According to exemplary embodiments of the present application, the electrical characteristics of the driving transistor are compensated.

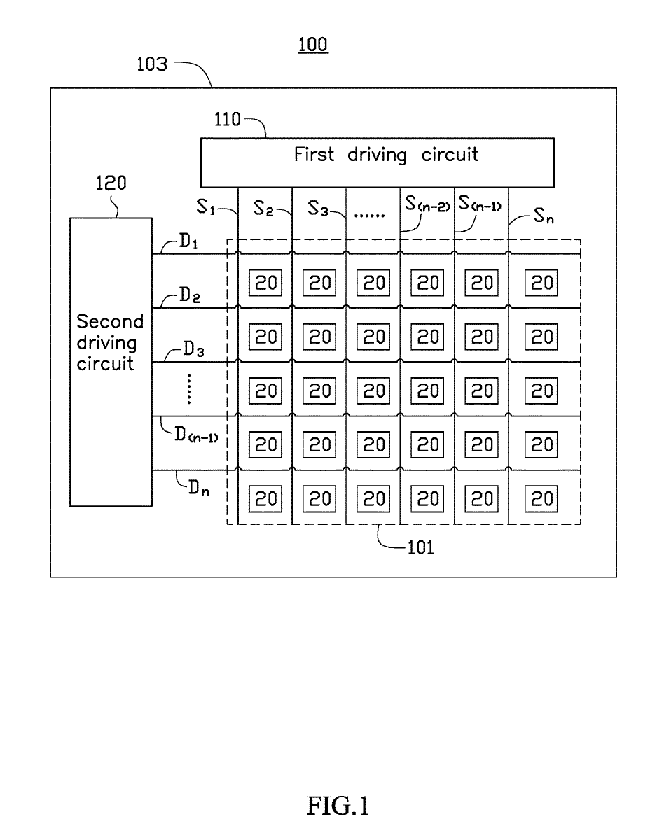

FIG. 1 illustrates an exemplary embodiment of a display apparatus 100.

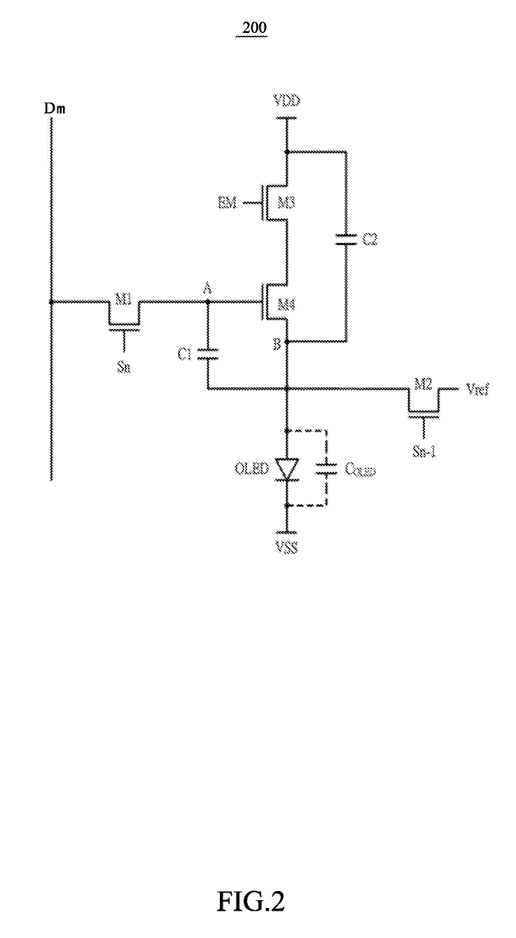

In at least one exemplary embodiment, the display apparatus 100 is for example an organic light emitting diode (OLED) device. The display apparatus 100 defines a display region 101 and a non-display region 103 surrounded with the display region 101. The display apparatus 100 includes a plurality of scan lines S₁-Sₙ extending along a first direction X and a plurality of data lines D₁-Dₘ extending along a second direction Y perpendicular to the first direction X. The scan lines S₁-Sₙ and the data lines D₁-Dₘ cross with each other in a grid to define a plurality of pixel units 20. The scan lines S₁-Sₙ are insulated from the data lines D₁-Dₘ. The scan lines S₁-Sₙ are electrically connected to a first driving circuit 110, and the data lines D₁-Dₘ are electrically connected to a second driving circuit 120. Main portions of the scan lines S₁-Sₙ and the data lines D₁-Dₘ are located in the display region 101. The first driving circuit 110 and the second driving circuit 120 are located on the non-display region 103. In at least one exemplary embodiment, the first driving circuit 110 is located upon the display region 101, and the second driving circuit 120 is located on a left side of the display region 101. The first driving circuit 110 can be a gate driving circuit, and the second driving circuit 120 can be a source driving circuit configured to provide data signals to each pixel unit 20. Each of the pixel units 20 includes to a pixel driving circuit 200 (as shown in FIG. 2). The first driving circuit 110 sequentially outputs scan driving signals to the pixel units 20.

FIG. 2 illustrates a first exemplary embodiment of the pixel driving circuit 200 corresponding to one of the pixel units 20. The pixel driving circuit 200 receives signals from a first scan line Sₙ, a second scan line Sₙ₋₁, a control line EM, and a data line Dₘ. The pixel driving circuit 200 further receives a first direct current (DC) voltage from a power terminal V_{DD}, a second voltage from an initial terminal V_{ref}, and a third voltage from a ground terminal V_{SS}. The pixel driving circuit 200 is a is formed as a 4T-2C type driving circuit, and includes a switching transistor M1, a reset transistor M2, a first transistor M3, a driving transistor M4, an organic light emitting diode (OLED), a first capacitor C1, and a second capacitor C2. The OLED further includes a spastic capacitor C_{OLED}. The switching transistor M1, the reset transistor M2, and the first transistor M3 are respectively controlled by the signal on the first scan line S₁, the second scan line S₂, and the control line EM. The driving transistor M4 controls a current following through the OLED. The switching transistor M1 controls an operation to supply an electric potential of the data line Dₘ to the driving transistor M4. The first capacitor C1 stores the electric potential on the data line Dₘ during one frame, and cooperates with the second capacitor C2 to divide the electric potential at the second node B. The reset transistor M2 controls an operation to supply a signal electric potential on the second scan line Sₙ₋₁ to a drain electrode of the driving transistor M4. The first transistor M3 controls a current from the power terminal V_{DD} to be supplied to the OLED. In at least one exemplary embodiment, the switching transistor M1, the reset transistor M2, the first transistor M3, and the driving transistor M4 can be a n-type polysilicon thin film transistors. In other embodiments, the switching transistor M1, the reset transistor M2, the first transistor M3, and the driving transistor M4 can be n-type amorphous silicon thin film transistors. In at least one exemplary embodiment, the first scan line Sₙ and the second scan line Sₙ₋₁ are two adjacent lines of the scan lines S₁-Sₙ, and the data line Dₘ is one of the data lines D₁-Dₘ. That is, each pixel unit 20 corresponds to or connects to two adjacent scan lines and one date line. A gate electrode of the switching transistor M1 is electrically to the scan line Sₙ, and a gate electrode of the reset transistor M2 is electrically connected to the adjacent scan line S₍ₙ₋₁₎, and a gate electrode of the first transistor M3 is electrically connected to the control line EM.

A gate electrode of the switching transistor M1 is electrically connected to the first scan line Sₙ, a source electrode of the switching transistor M1 is electrically connected to the data line Dₘ, and a drain electrode of the switching transistor M1 is electrically connected to a gate electrode of the driving transistor M4. A first node A is electrically connected between the drain electrode of the switching transistor M1 and the gate electrode of the driving transistor M4. A source electrode of the driving transistor M4 is electrically connected to a drain electrode of the first transistor M3, and a drain electrode of the driving transistor M4 is electrically connected to an anode of the OLED. A second node B is electrically connected between the drain electrode of the driving transistor M4 and the anode of the OLED. A cathode of the OLED is electrically connected to the ground terminal V_{SS}. A gate electrode of the first transistor M3 is electrically connected to the control line EM, and a source electrode of the first transistor M3 is electrically connected to the power terminal V_{DD}. A gate electrode of the reset transistor M2 is electrically connected to the second scan line Sₙ₋₁, a source electrode of the reset transistor M2 is electrically connected to the second node B, and a drain electrode of the reset transistor M2 is electrically connected to the initial terminal V_{ref}. Two opposite terminals of the first capacitor C1 are electrically connected to the gate electrode of the driving transistor M4 and the drain electrode of the driving transistor M4 respectively. Two opposite terminals of the parasitic capacitor C_{OLED} are electrically connected between the anode of the OLED and the cathode of the OLED respectively. One terminal of the second capacitor C2 is electrically connected to the source electrode of the first transistor M3, and another terminal of the second capacitor C2 is electrically connected to the drain electrode of the driving transistor M4. In at least one exemplary embodiment, signals provided on the first scan line Sₙ, the second scan line Sₙ₋₁, and the control line EM are switched between a low level voltage and a high level voltage, and the signal provided by the data line Dₘ is switched between an offset electric potential V_{bias} and a signal electric potential V_{data}. The offset electric potential V_{bias} is lower than the signal electric potential V_{data}. The offset electric potential V_{bias} is served as a reference voltage of the signal electric potential V_{data} (equivalent to be a black level), and the signal electric potential V_{data} is a voltage of video signal to be displayed by the display apparatus 100. In at least one exemplary embodiment, the power terminal V_{DD} supplies a specified voltage, and connects with all the pixel units 20 respectively. The specified voltage is a high level voltage, and is capable of providing a current to the OLED during the first transistor M3 turns on. In at least one exemplary embodiment, the initial terminal V_{ref} is in a low level voltage state.

Furthermore, the driving transistor M4 is a driving thin film transistor, employed to drive the OLED to emit light.

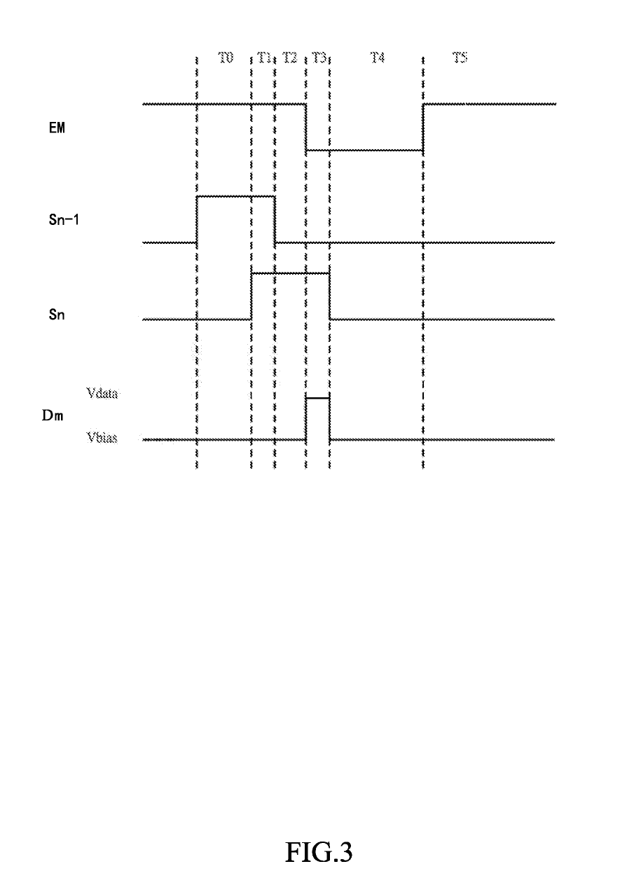

FIG. 3 illustrates a timing diagram of a signal of the control line EM, a scanning signal of the first scan line Sₙ, a scanning signal of the second scan line Sₙ₋₁, the data signal provided on the data line Dₘ of the pixel driving circuit 200. The pixel driving circuit 200 operates sequentially within one frame time comprising a reset period T0, a preparation compensation period T1, a compensation period T2, a programming period T3, an illumination duty period T4, and an illumination period T5.

During the reset period T0, the pixel driving circuit 200 is reset and the OLED stops emitting light. During the preparation compensation period T1, the first capacitor C1 is being charged for compensating a threshold voltage degradation of the driving transistor M4. During the compensation period T2, the electric potential of the second node B rises based on the current flowing from the driving transistor M4 to the first capacitor C1. During the programming period T3, the data signal on the data line Dₘ is supplied to the gate of the driving transistor M4. During the illumination duty period T4, the pixel driving circuit 200 remains the electric potential of the second node B. During the illumination period T5, a current is supplied to the OLED for emitting light by sequentially passing through the first transistor M3 and the driving transistor M4.

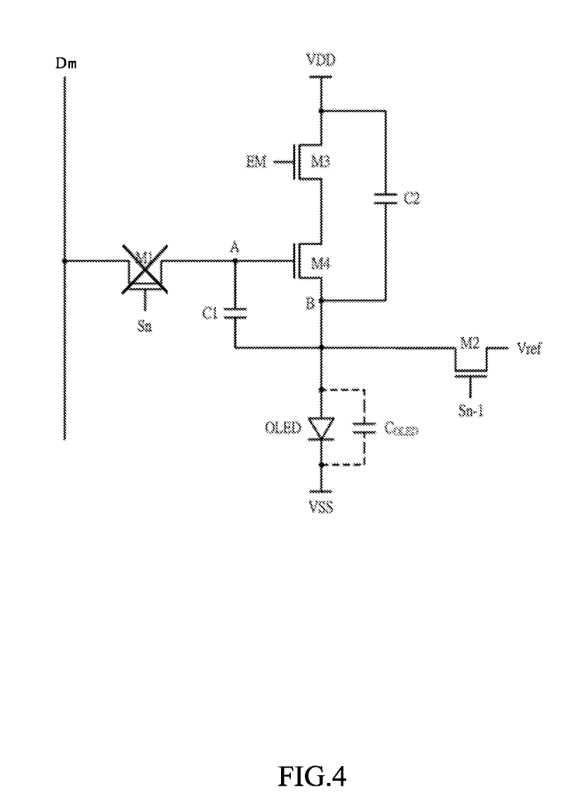

FIG. 4 is a circuit diagram view of the pixel driving circuit 200 in the reset period T0. During the reset period T0, the scanning signal of the first scan line Sₙ₋₁ and the control signal EM are in high level voltage, and the scanning signal of the second scan line Sₙ is in low level voltage, and the offset electric potential V_{bias} is provided to the data line Dₘ. The switching transistor M1 is turned off. The reset transistor M2 and the first transistor M3 remain in a turned-on state. The electric potential of the second node B is equal to the reference voltage V_{ref}. When the reference voltage V_{ref} is less than the second voltage V_{SS}, the voltage difference between the anode and the cathode of the OLED is less than a forward voltage of the OLED, the OLED will be in a non-luminance state.

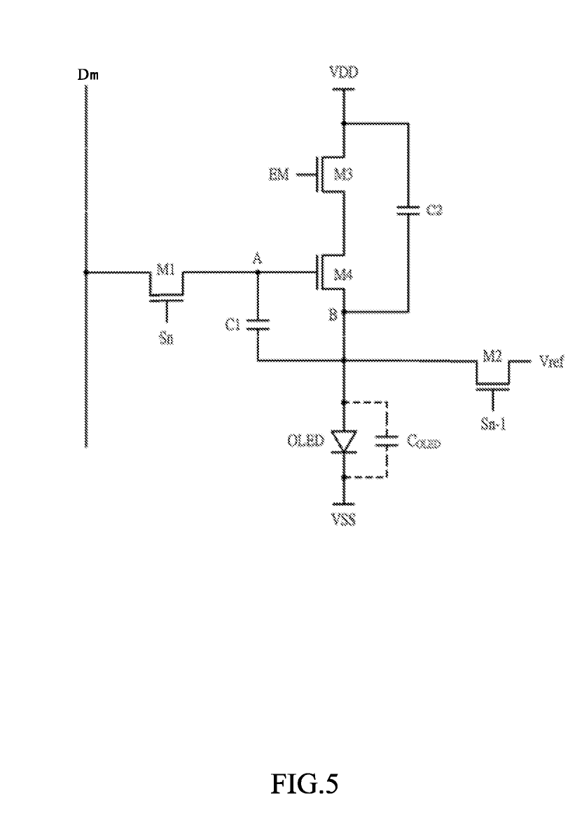

FIG. 5 is a circuit diagram view of the pixel driving circuit 200 in the preparation compensation period T1. During the preparation compensation period T1, the scanning signals of the first scan line Sₙ₋₁, the second scan line Sₙ, and the control signal EM are in high level voltage, and the offset electric potential V_{bias} is provided to the data line Dₘ. The offset electric potential V_{bias} is provided to the gate electrode of the driving transistor M4, and the first capacitor C1 is charged. The difference between the offset electric potential V_{bias} and the ground terminal V_{SS} is larger than a threshold voltage of the driving transistor M4, thus the driving transistor M4 turns on. The electric potential of the first node A is equal to the offset electric potential V_{bias}, and the electric potential of the second node B is equal to the initial terminal V_{ref}. The voltage difference between the anode and the cathode of the OLED is less than the forward voltage of the OLED, the OLED to maintain in the non-luminance state.

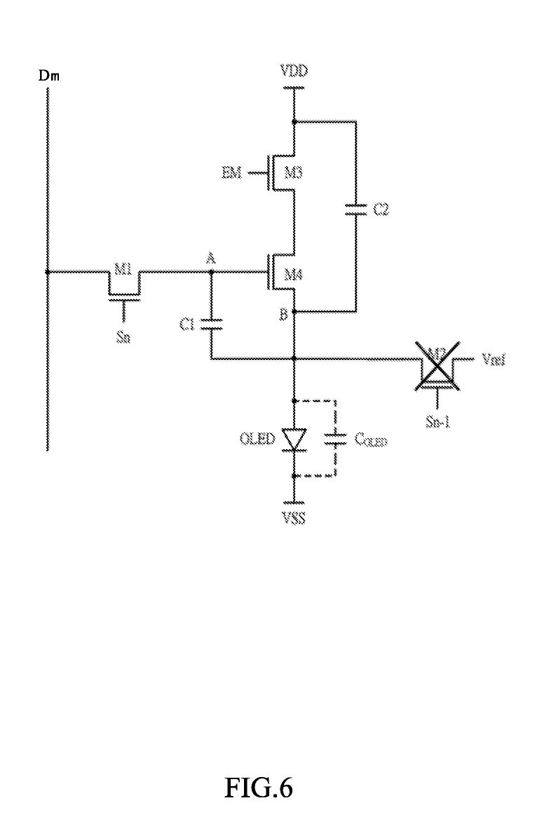

FIG. 6 is a circuit diagram view of the pixel driving circuit 200 in the compensation period T2. During the compensation period T2, the scanning signal of the second scan line Sₙ and the signal of the control signal EM are in high level voltage, the scanning signal of the first scan line Sₙ₋₁ is in low level voltage, and the offset electric potential V_{bias} is provided to the data line Dₘ. The reset transistor M2 is turned off. The electric potential of the second node B starts rise based a current flowing from the first transistor M3 and the driving transistor M4. The electric potential of the second node B is equal to a difference between offset electric potential V_{bias} and a threshold voltage of the driving transistor M4. The voltage difference between the anode and the cathode of the OLED is less than the forward voltage of the OLED, the OLED to maintain in the non-luminance state.

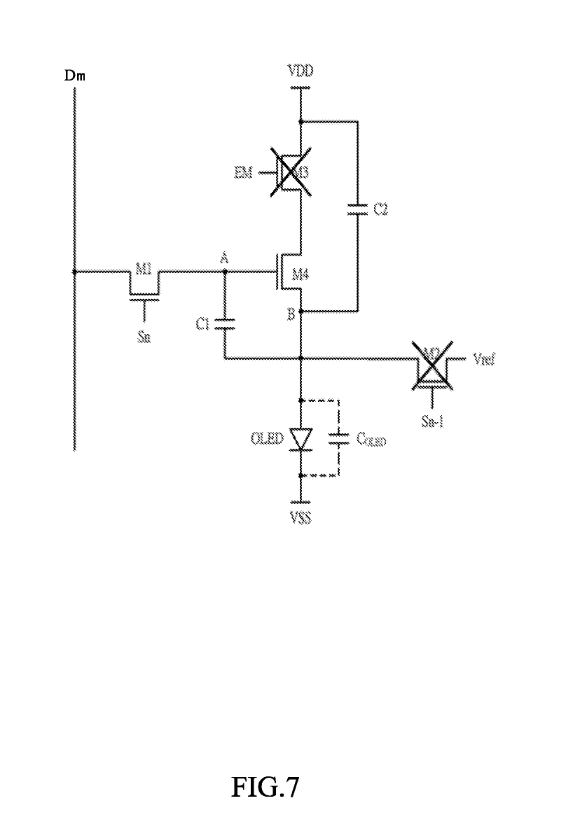

FIG. 7 is a circuit diagram view of the pixel driving circuit 200 in the programming period T3. During the programming period T3, the scanning signals of the second scan line Sₙ is in high level voltage, the scanning signal of the first scan line Sₙ₋₁ and the control signal EM is in low level voltage, and the signal electric potential V_{data} is provided to the data line Dₘ. The reset transistor M2 remains in the turned off state, and the first transistor M3 is turned off. The signal electric potential V_{data} is provided to the gate electrode of the driving transistor M4 by passing through the switching transistor M1, thus the driving transistor M4 turns on. The capacitor C_{OLED} is charged by the difference of the signal electric potential V_{data} and the offset electric potential V_{bias}, and thus the electric potential of the second node B rises. The electric potential of the second node B is a sum of the electric potential at the compensation period and the electric potential risen by the charged capacitor C_{OLED}. The electric potential of the second node B is calculated by the following formula:

V_{B}=V_{bias}−Vₜₕ+[(V_{data}−V_{bias})C1/(C1+C_{OLED})] (1)

The voltage difference between the anode and the cathode of the OLED is less than the forward voltage of the OLED, which cause the OLED to maintain in the non-luminance state.

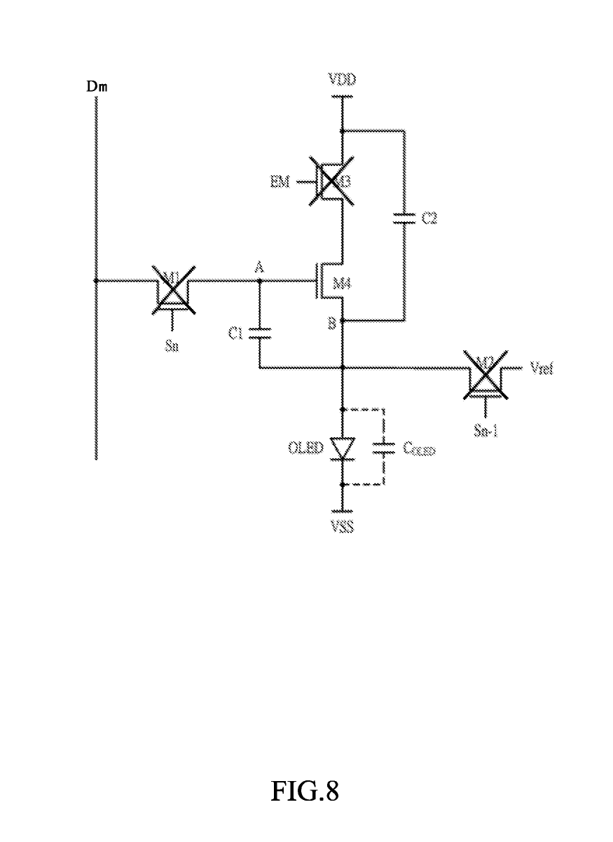

FIG. 8 is a circuit diagram view of the pixel driving circuit 200 in the illumination duty period T4. During the illumination duty period T4, the scanning signals of the second scan line Sₙ, the first scan line Sₙ₋₁, and the signal of the control signal EM is in low level voltage, and the offset electric potential V_{bias} is provided to the data line Dₘ. The switching transistor M1 turns off, and the reset transistor M2 and the first transistor M3 remains in the turned off state. The illumination duty period T4 is an adjustment period for adjusting the luminescence of the OLED. The electric potential of the second node B remains being equal to the electric potential of the second node B in the programming period T3. The voltage difference between the anode and the cathode of the OLED is less than the forward voltage of the OLED, which cause the OLED to maintain in the non-luminance state.

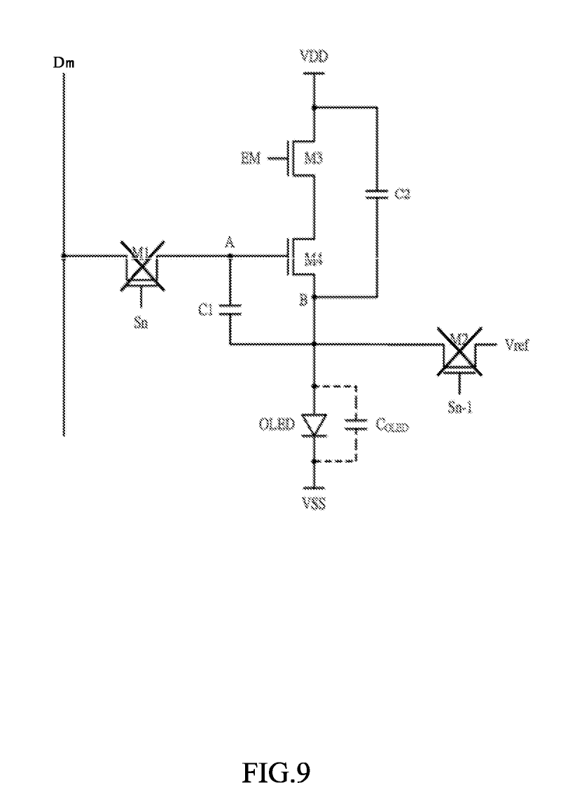

FIG. 9 is a circuit diagram view of the pixel driving circuit 200 in the illumination period T5. During the illumination period T5, the signal of the control signal EM is in high level voltage, the scanning signals of the first scan line Sₙ₋₁ and the second scan line Sₙ are in low level voltage, and the offset electric potential V_{bias} is provided to the data line Dₘ. The switching transistor M1 and the reset transistor M2 remain in a turned off state, thus the gate electrode of the driving transistor M4 is floated. The electric potential of the first node A is calculated according to the follow formula:

V_{A}=V_{data}+(V_{OLED}−[(V_{bias}−Vₜₕ)+(V_{data}−V_{bias})*C1/(C1+C2+C_{OLED})]) (2)

The control signal EM is in the high level voltage, the first transistor M3 is turned on, and the driving transistor M4 further supplies the current to the OLED. The electric potential of the second node B is more than the forward voltage of the OLED. The voltage difference between the anode and the cathode of the OLED is more than the forward voltage of the OLED, which cause the OLED to emit light.

The current of the OLED is calculated according to the follow formula:

$$\begin{matrix}\begin{matrix}{I}_{OLED} = k * {( {V}_{GS} - {V}_{th} )}^{2} \\ = k * {( {V}_{A} - {V}_{B} - {V}_{th} )}^{2} \\ = k * {\{ ( {V}_{data} - {V}_{bias} ) * [ 1 - C 1 / ( C 1 + C 2 + {C}_{OLED} ) ] \}}^{2}\end{matrix} & ( 3 ) \\ k = 1 / 2 * μ * {C}_{OX} * W / L & ( 4 )\end{matrix}$$

μ represents a mobility ratio of the driving transistor M4, C_{OX} represents a capacitance of the gate dielectric layer of the driving transistor M4. W represents a width of the channel of the driving transistor M4. L represents a length of the channel of the driving transistor M4.

In the structure of the pixel driving circuit under the periods in one frame, due to the illumination duty period, the illumination time of the OLED can be adjusted. Thereby, a performance of the display apparatus is improved. The gate electrodes of the switching transistor and the reset transistor are electrically connected to the two adjacent scan lines, thus the number of the shift register module for driving the pixel driving circuit is reduced.

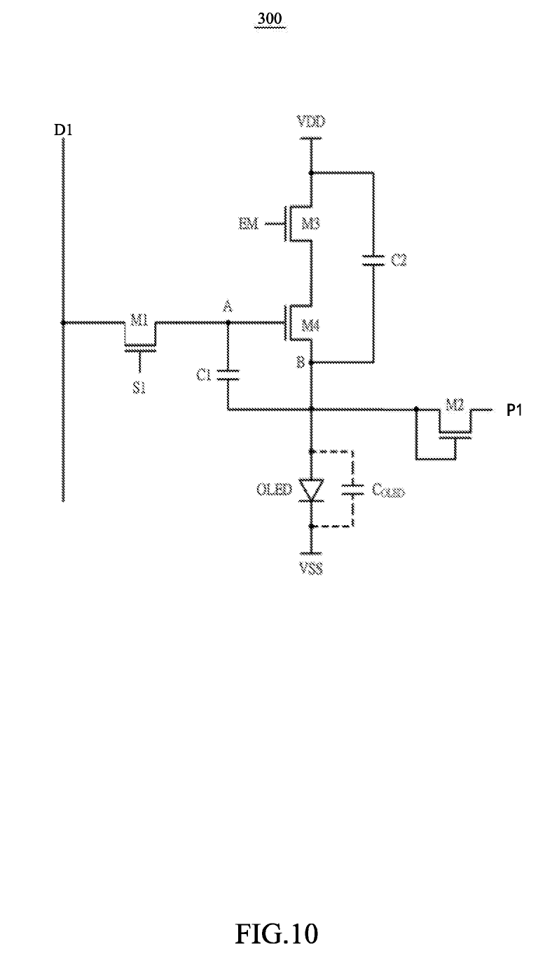

FIG. 10 illustrates a second exemplary embodiment of the pixel driving circuit 300 corresponding to one of the pixel units 20. The pixel driving circuit 300 receives signals from a first scan line S₁, a power line P1, a control line EM, and a data line D₁. The pixel driving circuit 300 further receives a first direct current (DC) voltage from a power terminal V_{DD} and a voltage from a ground terminal V_{SS}. The pixel driving circuit 300 is a is formed as a 4T-2C type driving circuit, and includes a switching transistor M1, a reset transistor M2, a first transistor M3, a driving transistor M4, an organic light emitting diode (OLED), a first capacitor C1, and a second capacitor C2. The OLED includes a spastic capacitor C_{OLED}. The switching transistor M1, the reset transistor M2, and the first transistor M3 are respectively controlled by the signal on the first scan line S₁, the power line P1, and the control line EM. The driving transistor M4 controls a current following through the OLED. The switching transistor M1 controls an operation to supply an electric potential on the data line D₁ to the driving transistor M4. The first capacitor C1 stores the electric potential on the data line D₁ during one frame, and cooperates with the second capacitor C2 to divide an electric potential at the second node B. The reset transistor M2 serves as a diode and controls an operation to supply an alternating current AC to a drain electrode of the driving transistor M4. The first transistor M3 controls a current from the power terminal V_{DD} to be supplied to the OLED. In at least one exemplary embodiment, the first switching transistor M1, the reset transistor M2, the first transistor M3, and the driving transistor M4 can be a n-type polysilicon thin film transistors. In other exemplary embodiments, the switching transistor M1, the reset transistor M2, the first transistor M3, and the driving transistor M4 can be n-type amorphous silicon thin film transistors. A gate electrode of the switching transistor M1 is electrically connected to the scan line S1, and a drain electrode of the reset transistor M2 is electrically connected to the control line EM.

A gate electrode of the switching transistor M1 is electrically connected to the first scan line S₁, a source electrode of the switching transistor M1 is electrically connected to the data line D₁, and a drain electrode of the switching transistor M1 is electrically connected to a gate electrode of the driving transistor M4. A first node A is electrically connected between the drain electrode of the switching transistor M1 and the gate electrode of the driving transistor M4. A source electrode of the driving transistor M4 is electrically connected to a drain electrode of the first transistor M3, and a drain electrode of the driving transistor M4 is electrically connected to an anode of the OLED. A second node B is electrically connected between the drain electrode of the driving transistor M4 and the anode of the OLED. A cathode of the OLED is electrically connected to the ground terminal V_{SS}. A gate electrode of the first transistor M3 is electrically connected to the control line EM, and a source electrode of the first transistor M3 is electrically connected to the power terminal V_{DD}. A gate electrode of the reset transistor M2 is electrically connected to a source electrode of the reset transistor M2, the source electrode of the reset transistor M2 is electrically connected to the second node B, and a drain electrode of the reset transistor M2 is electrically connected to the power line P1. Two opposite terminals of the first capacitor C1 are electrically connected to the gate electrode of the driving transistor M4 and the drain electrode of the driving transistor M4 respectively. Two opposite terminals of the parasitic capacitor C_{OLED} are electrically connected between the anode of the OLED and the cathode of the OLED respectively. One terminal of the second capacitor C2 is electrically connected to the source electrode of the first transistor M3, and another terminal of the second capacitor C2 is electrically connected to the drain electrode of the driving transistor M4. In at least one exemplary embodiment, signals provided on the first scan line S₁ and the control line EM are switched between a low level voltage and a high level voltage, and the signal provided by the data line D₁ is switched between an offset electric potential V_{bias} and a signal electric potential V_{data}. The offset electric potential V_{bias} is lower than the signal electric potential V_{data}. The offset electric potential V_{bias} is served as a reference voltage of the signal electric potential V_{data} (equivalent to be a black level), and the signal electric potential V_{data} is a voltage of video signal to be displayed by the display apparatus 100. In at least one exemplary embodiment, the power terminal V_{DD} supplies a specified voltage, and connects with all the pixel units 20 respectively, and the power line P1, is applied with an alternating signal with a predetermined frequency. The specified voltage is a high level voltage, and is capable of providing a current to the OLED during the first transistor M3 turns on.

Furthermore, the driving transistor M4 is a driving thin film transistor, employed to drive the organic light emitting diode to emit light.

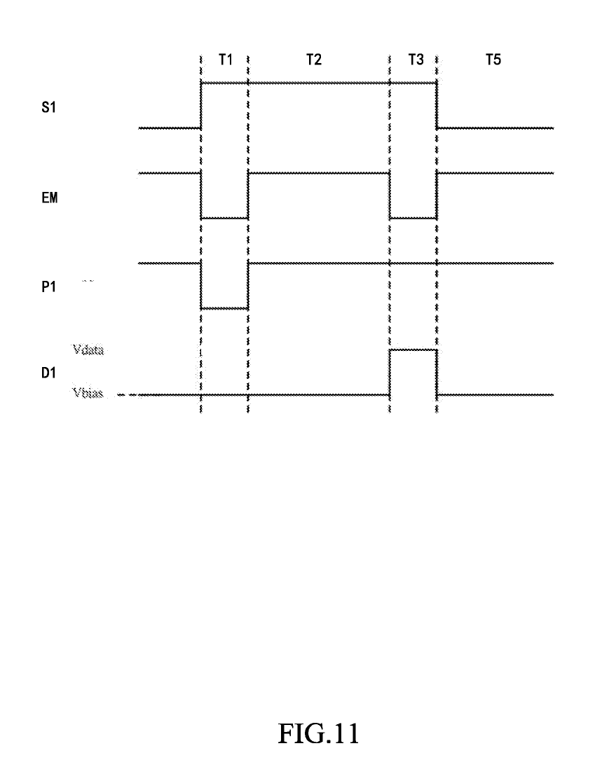

FIG. 11 illustrates a timing diagram of a signal of the control line EM, a scanning signal of the first scan line S₁, a scanning signal of the power line P1, the data signal provided on the data line D₁ of the pixel driving circuit 300. The pixel driving circuit 300 operates sequentially within one frame time comprising a preparation compensation period T1, a compensation period T2, a programming period T3, and an illumination period T5.

During the preparation compensation period T1, the first capacitor C1 is being charged for compensating a threshold voltage degradation of the driving transistor M4. During the compensation period T2, the voltage of the second node B rises based on the current flowing from the driving transistor M4 to the first capacitor C1. During the programming period T3, the data on the data line D₁ is supplied to the gate of the driving transistor M4. During the illumination period T4, a current is supplied to the OLED for emitting light by sequentially passing through the third switching transistor M3 and the driving transistor M4.

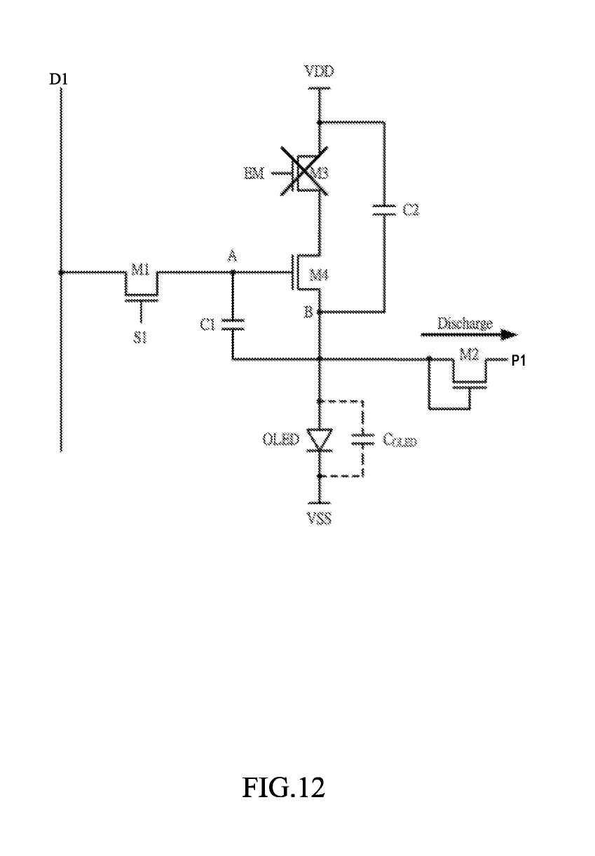

FIG. 12 is a circuit diagram view of the pixel driving circuit 300 in the preparation compensation period T1. During the preparation compensation period T1, the scanning signals of the first scan line S₁ and the power line P1 are in high level voltage, the control signal EM is in low level voltage, and the offset electric potential V_{bias} is provided to the data line D₁. The first switching transistor M1 turns on, the offset electric potential V_{bias} is provided to the gate electrode of the driving transistor M4 through the switching transistor M1, and the first capacitor C1 is charged. The difference between the offset electric potential V_{bias} and the ground terminal V_{SS} is larger than a threshold voltage of the driving transistor M4, thus the driving transistor M4 turns on. The second capacitor C2 discharges through the reset transistor M2. The voltage of the first node A is still equal to the offset electric potential V_{bias}, and the voltage of the second node B is equal to a sum of the threshold voltage of the driving transistor M4 and the electric potential of the power line P1, and is less than the forward voltage of the OLED. The voltage difference between the anode and the cathode of the OLED is less than the forward voltage of the OLED, the OLED will be in a non-luminance state.

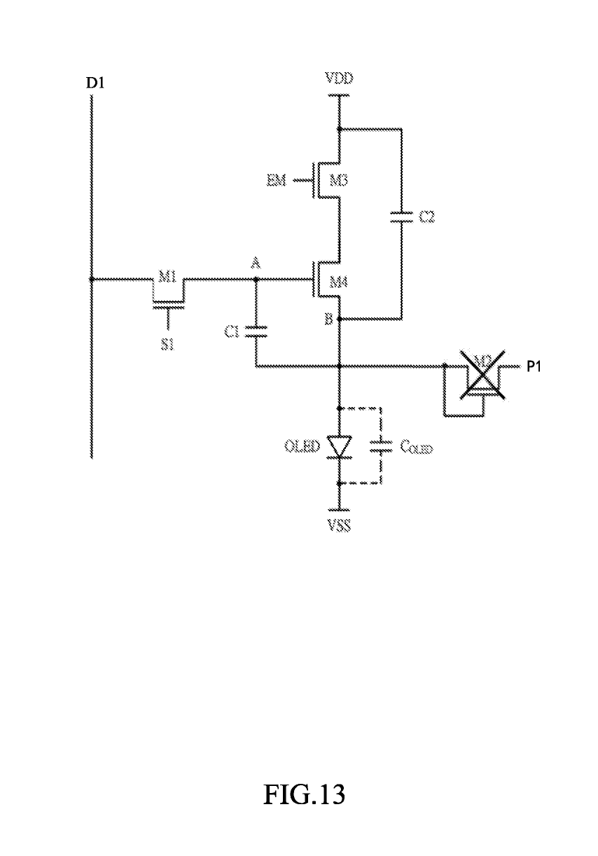

FIG. 13 is a circuit diagram view of the pixel driving circuit 300 in the compensation period T2. During the compensation period T2, the scanning signals of the first scan line S₁, the power line P1, and the signal of the control signal EM are in high level voltage, and the offset electric potential V_{bias} is provided to the data line D₁. The first transistor M3 turns on, and the voltage of the second node B starts rise based a current flowing from the first transistor M3 and the driving transistor M4. The voltage of the second node B is equal to a difference between offset electric potential V_{bias} and the threshold voltage of the driving transistor M4. The voltage difference between the anode and the cathode of the OLED is less than the forward voltage of the OLED, the OLED to maintain in the non-luminance state.

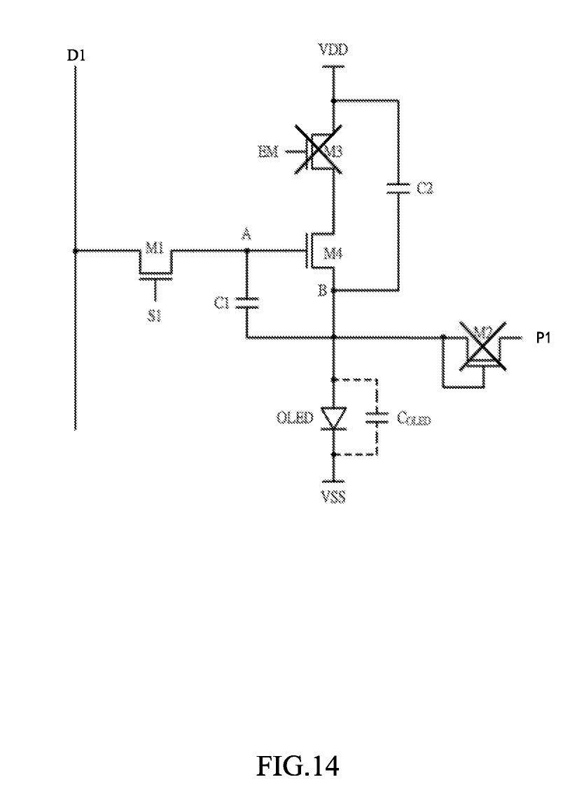

FIG. 14 is a circuit diagram view of the pixel driving circuit 300 in the programming period T3. During the programming period T3, the scanning signals of the first scan line S₁ and the power line P1 is in high level voltage, the control signal EM is in low level voltage, and the signal electric potential V_{data} is provided to the data line D1. The reset transistor M2 remains in the turned off state, and the first transistor M3 is turned off. The signal electric potential V_{data} is provided to the gate electrode of the driving transistor M4 by passing through the switching transistor M1, thus the driving transistor M4 turns on. The capacitor C_{OLED} is charged by the difference of the signal electric potential V_{data} and the offset electric potential V_{bias}, and thus the voltage of the second node B rises. The voltage of the second node B is a sum of the voltage at the compensation period and the voltage risen by the charged capacitor C_{OLED}. The voltage of the second node B is calculated by the following formula:

V_{B}=V_{bias}−Vₜₕ+[(V_{data}−V_{bias})C1/(C1+C_{OLED})] (1)

The voltage difference between the anode and the cathode of the OLED is less than the forward voltage of the OLED, which cause the OLED to maintain in the non-luminance state.

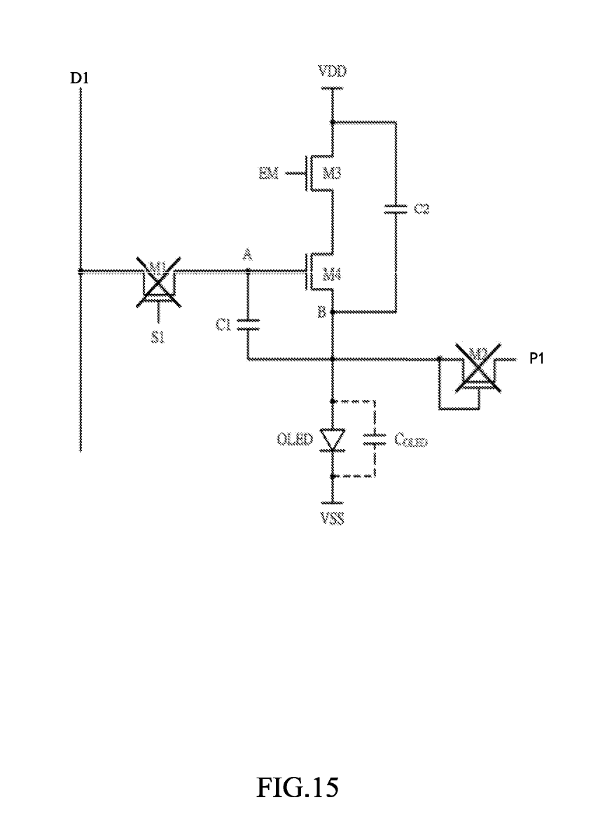

FIG. 15 is a circuit diagram view of the pixel driving circuit 200 in the illumination period T5. During the illumination period T5, the scanning signal of the power line P1 is in high level voltage, the scanning signal of the first scan line S₁, and the signal of the control signal EM is in low level voltage, and the offset electric potential V_{bias} is provided to the data line D₁. The first switching transistor M1 is turned off, thus the gate electrode of the driving transistor M4 is floated. The voltage of the first node A is calculated according to the follow formula:

V_{A}=V_{data}+(V_{OLED}−[(V_{bias}−Vₜₕ)+(V_{data}−V_{bias})*C1/(C1+C2+C_{OLED})]) (2)

The control signal EM is in the high level voltage, the first transistor M3 is turned on, and the driving transistor M4 further supplies the current to the OLED. The voltage of the second node B is equal to the forward voltage of the OLED. The voltage difference between the anode and the cathode of the OLED is more than the forward voltage of the OLED, which cause the OLED to emit light.

The current of the OLED is calculated according to the follow formula:

$$\begin{matrix}\begin{matrix}{I}_{OLED} = k * {( {V}_{GS} - {V}_{th} )}^{2} \\ = k * {( {V}_{A} - {V}_{B} - {V}_{th} )}^{2} \\ = k * {\{ ( {V}_{data} - {V}_{bias} ) * [ 1 - C 1 / ( C 1 + C 2 + {C}_{OLED} ) ] \}}^{2}\end{matrix} & ( 3 ) \\ k = 1 / 2 * μ * {C}_{OX} * W / L & ( 4 )\end{matrix}$$

μ represents a mobility ratio of the driving transistor M4, C_{OX} represents a capacitance of the gate dielectric layer of the driving transistor M4. W represents a width of the channel of the driving transistor M4. L represents a length of the channel of the driving transistor M4.

In the structure of the pixel driving circuit, the reset transistor serves as a diode, and connects with an alternating current (AC) voltage terminal. The gate electrode of the switching transistor is electrically connected to the scan line, and the first transistor is electrically connected to the control line, thus a number of the shift register modules for driving the pixel driving circuit is reduced.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims.

What is claimed is:

1. A display apparatus comprising:
a plurality of scan lines;
a plurality of data lines;
a plurality of pixel units;
a first driving circuit for providing a plurality of scanning signals to the plurality of pixel units; and
a plurality of pixel driving circuits each corresponding to one of the plurality of pixel units, and configured to drive the corresponding pixel unit;
wherein each pixel driving circuit comprises a switching transistor (M1), a driving transistor (M4), an organic light emitting diode (OLED) and a reset transistor (M2), the OLED emits light when a current flowing therethrough, the driving transistor controls a current following through the OLED, the switching transistor supplies a voltage of a data signal supplied by a corresponding one of the data lines to the driving transistor in response to a corresponding scan line being selected, and the reset transistor pulls down a voltage applied on the driving transistor during a reset period under a control of a received another scanning signal having a phase previous to the scanning signal applied on the corresponding scan line being selected.

2. The display apparatus of claim 1, wherein the corresponding scan line being selected is defined as an Nth scan line, and a control terminal of the reset transistor is connected to an (N−1)th scan line.

3. The display apparatus of claim 1, wherein the display apparatus further comprises a power supply terminal, the pixel driving circuit further comprises a first transistor connected between the driving transistor and the power supply terminal, a first capacitor, and a second capacitor connected between the power supply voltage and an anode electrode of the OLED, in a frame of driving the pixel driving circuits includes a data programming period during which the first capacitor is charged by data signals applied via a corresponding data line, and an emission period during which the OLED emits light, and the frame further includes an illumination duty period between the charging period and the emission period, in the illumination duty period, the switching transistor, the driving transistor and the first transistor are in a switching-off status.

4. The display apparatus of claim 3, wherein a source electrode of the switching transistor is electrically connected to the corresponding one of the plurality of data lines, and a drain electrode of the switching transistor is electrically connected to a gate electrode of the driving transistor; a source electrode of the driving transistor is electrically connected to a drain electrode of the first transistor, and a drain electrode of the driving transistor is electrically connected to an anode of the OLED; a cathode of the OLED is electrically connected to the ground terminal; a source electrode of the first transistor is electrically connected to the power supply terminal; a source electrode of the reset transistor is electrically connected to the source electrode of the driving transistor, and a drain electrode of the reset transistor is electrically connected to an initial terminal; two opposite terminals of the first capacitor are electrically connected to the gate electrode of the driving transistor and the drain electrode of the driving transistor respectively; one terminal of the second capacitor is electrically connected to the source electrode of the first transistor, and another terminal of the second capacitor is electrically connected to the drain electrode of the driving transistor.

5. The display apparatus of claim 3, wherein the frame further comprises a preparation compensation period, and a compensation period; the reset period, the preparation compensation period and the compensation period are operated before the programming period, the illumination duty period, and the illumination period; during the reset period, the switching transistor is in a switching-off status, the first capacitor is being discharged; during the preparation compensation period, the first capacitor is being charged, during the compensation period, the first capacitor is further charged for compensating a threshold voltage of the driving transistor.

6. A display apparatus comprising:
a plurality of scan lines;
a plurality of data lines;
a plurality of pixel units;
a first driving circuit for providing a plurality of scanning signals to the plurality of pixel units; and
a plurality of pixel driving circuits each corresponding to one of the plurality of pixel units, and configured to drive the corresponding pixel unit;
wherein each pixel driving circuit comprises a switching transistor (M1), a driving transistor (M4), an organic light emitting diode (OLED) and a reset transistor (M2), the OLED emits light when a current flowing therethrough, the driving transistor controls a current following through the OLED, a switching transistor supplies a voltage of a data signal supplied by a corresponding one of the data lines to the driving transistor in response to a corresponding scan line being selected, and the reset transistor servers as a diode, and pulls down a voltage applied on the driving transistor during a reset period under a control of an alternating signal.

7. The display apparatus of claim 6, wherein a gate electrode of the reset transistor is electrically connected to a source of the reset transistor, and a drain electrode of the reset transistor receives the alternating current.

8. The display apparatus of claim 6, wherein in one frame the pixel driving circuit sequentially operates a reset period, a compensation period, a programming period, and an illumination period; during a reset period, the first capacitor is discharged, during a compensation period, the first capacitor is charged for compensating a threshold voltage of the driving transistor, during the programming period, the first capacitor is charged by data signals applied via a corresponding data line, and during the illumination period, the OLED emits light beams.

9. The display apparatus of claim 6, wherein a source electrode of the switching transistor is electrically connected to the data line, and a drain electrode of the switching transistor is electrically connected to a gate electrode of the driving transistor; a source electrode of the driving transistor is electrically connected to a drain electrode of the first transistor, and a drain electrode of the driving transistor is electrically connected to an anode of the OLED; a cathode of the OLED is electrically connected to the ground terminal; a source electrode of the first transistor is electrically connected to a power terminal; two opposite terminals of the first capacitor are electrically connected to the gate electrode of the driving transistor and the drain electrode of the driving transistor respectively; one terminal of the second capacitor is electrically connected to the source electrode of the first transistor, and another terminal of the second capacitor is electrically connected to the drain electrode of the driving transistor.
